(19) United States
(12) Patent Application Publication
(10) Pub. No.: US 2020/0208714 A1
(43) Pub. Date: Jul. 2, 2020

(54) COVER FOR ROPE OR CABLE LOOP END

(71) Applicant: MILE MARKER INDUSTRIES, LLC, Pompano Beach, FL (US)

(72) Inventor: Tyler Ferris, Pompano Beach, FL (US)

(21) Appl. No.: 16/233,759

(22) Filed: Dec. 27, 2018

(51) Int. Cl. F16G 11/00; D07B 9/00

(52) U.S. Cl. CPC F16G 11/00; D07B 9/00; D07B 2205/2075; D07B 2201/2095; D07B 2501/2092

(57) ABSTRACT

A device configured for attachment to a loop end of a recovery winch rope or cable includes a hood element configured to fit over and around the loop end of the recovery winch rope or cable, wherein the hood element covers outward facing surfaces of the loop end, orifices located on either side of the hood element and aligned with an opening in the loop end, such that a continuous open space extends through the opening of the loop end, a base coupled to the hood element, the base being sized to prevent passage through a fairlead of the recovery winch, a removable cap located in the base, wherein the cap includes a space that allows the rope or cable to extend therethrough, and, wherein the hood element, the base and cap are composed of an elastomeric polymer.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to rigging and vehicle recovery and, more specifically, to devices for improving the efficiency and strength thereof.

### BACKGROUND

It is commonplace for outdoor vehicles to include a recovery winch. A recovery winch is a mechanical device, usually located at the front of the vehicle, that consists of a spool and a rope or cable. Recovery winches are used by off road drivers to extract their vehicles from an obstacle, such as a ditch, in which the vehicle is stuck. The device is used to pull in (wind up), let out (wind out) or otherwise adjust the tension of the rope or cable. At the end of the rope or cable, there is a loop end, which is a loop of rope or cable. Another piece of hardware may be attached to the loop end, in order to provide a method of removably attaching the rope or cable to a stationary object such as a tree, via a rope sling. Also, attaching another piece of hardware to the loop end prevents the rope or cable from being pulled in through the fairlead opening of the fairlead of the winch when the rope or cable is pulled in or wound up.

In one embodiment, a D-ring, a hook, a shackle or a shackle mount fitting (as described in U.S. Pat. No. 9,388,025) may be attached to the loop in order to provide a method of removably attaching the rope to another item, and to prevent the rope or cable from being pulled in through the fairlead opening. There are, however, several disadvantages to doing so. Attaching a D-ring, a hook, a shackle or a shackle mount fitting to the loop end results in limiting the capabilities of the system by introducing an additional failure point. The D-ring, hook, shackle or shackle mount fitting is installed along the load path between the stationary object and the rope or cable and can compromise the integrity of the load path in the event that a manufacturing or material defect occurs. The D-ring, hook, shackle or shackle mount fitting is also repeatedly loaded, meaning damage from use and fatigue wear are concerns that must be considered. Further, the cost of manufacturing a D-ring, a hook, a shackle or a shackle mount fitting can be expensive and time consuming, since they are load-bearing parts, and the materials used must be certified and strictly monitored.

There are also cosmetic considerations when attaching hardware, such as a D-ring, a hook, a shackle or a shackle mount fitting to a loop end. When the rope or cable is pulled in or wound up, the hardware attached to the loop end eventually contacts the fairlead. Upon contact with the fairlead, the hardware can scuff or scratch the fairlead, causing unsightly blemishes. This can be compounded by heavy or rough off-road activity which causes significant vibrations, thereby causing the hardware to further damage the fairlead. By the same token, the hardware attached to the loop end may itself become scuffed or scratched.

Therefore, a need exists for improvements over the prior art, and more particularly for improved systems and apparatuses for attaching hardware to a loop end of a rope or cable for a recovery winch.

### SUMMARY

A device configured for attachment to a loop end of a recovery winch rope or cable is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a device configured for attachment to a loop end of a recovery winch rope or cable includes a hood element configured to fit over and around the loop end of the recovery winch rope or cable, wherein the hood element covers outward facing surfaces of the loop end, orifices located on either side of the hood element and aligned with an opening in the loop end, such that a continuous open space extends through the opening of the loop end, a base coupled to the hood element, the base being sized to prevent passage through a fairlead of the recovery winch, a removable cap located in the base, wherein the cap includes a space that allows the rope or cable to extend therethrough, and, wherein the hood element, the base and cap are composed of an elastomeric polymer.

In another embodiment, a device configured for attachment to a loop end of a recovery winch rope or cable includes a shell including a void configured to accept the loop end of the recovery winch rope or cable, orifices located on either side of the shell and aligned with an opening in the loop end, such that a continuous open space extends through the opening of the loop end, a base coupled to the hood element, the base being sized to prevent passage through a fairlead of the recovery winch, a removable insert located in the base and at least partially filling the void of the shell, the insert configured to retain the loop end in the void, wherein the insert includes a space that allows the rope or cable to extend therethrough, and, wherein the shell, the base and insert are composed of an elastomeric polymer.

In another embodiment, a device configured for attachment to a loop end of a recovery winch rope or cable includes a hollow cover including a void configured to accept the loop end of the recovery winch rope or cable, orifices located on opposing sides of the cover and aligned with an opening in the loop end, such that a continuous open space extends through the opening of the loop end, a ring-shaped base coupled to the proximal end of the cover, a removable insert located in the base and at least partially filling the void of the cover, the insert configured to retain the loop end in the void, wherein the insert includes a cutout that allows the rope or cable to extend therethrough, and, wherein the cover, the base and the insert are composed of an elastomeric polymer.

### BRIEF DESCRIPTION OF THE DRAWINGS

The accompanying drawings, which are incorporated in and constitute a part of this disclosure, illustrate various example embodiments. In the drawings:

FIG. 1 is a drawing depicting a prior art loop end of a recovery winch rope or cable and a rope attached to a D-ring;

FIG. 2 is a drawing depicting the prior art loop end of the recovery winch rope or cable attached to the D-ring;

FIG. 3 is a drawing depicting a front perspective view of the device configured for attachment to a loop end of a recovery winch rope or cable, according to an example embodiment;

FIG. 4 is a drawing depicting a side view of the device configured for attachment to a loop end of a recovery winch rope or cable, according to an example embodiment;

FIG. 5 is a drawing depicting a top view of the device configured for attachment to a loop end of a recovery winch rope or cable, according to an example embodiment;

FIG. 6 is a drawing depicting another side view of the device configured for attachment to a loop end of a recovery winch rope or cable, according to an example embodiment;

FIG. 7 is a drawing depicting an interior side view of the device configured for attachment to a loop end of a recovery winch rope or cable, with the loop end inserted into the device, according to an example embodiment;

FIG. 8 is a drawing depicting a rear view of the device configured for attachment to a loop end of a recovery winch rope or cable, according to an example embodiment;

FIG. 9 is a drawing depicting a perspective frontal view of the hood or shell of the device configured for attachment to a loop end of a recovery winch rope or cable, according to an example embodiment;

FIG. 10 is a drawing depicting a bottom view of the hood or shell of the device configured for attachment to a loop end of a recovery winch rope or cable, according to an example embodiment;

FIG. 11 is a drawing depicting a frontal view of the hood or shell of the device configured for attachment to a loop end of a recovery winch rope or cable, according to an example embodiment;

FIG. 12 is a drawing depicting a rear view of the hood or shell of the device configured for attachment to a loop end of a recovery winch rope or cable, according to an example embodiment;

FIG. 13 is a drawing depicting a perspective rear view of the hood or shell of the device configured for attachment to a loop end of a recovery winch rope or cable, according to an example embodiment;

FIG. 14 is a drawing depicting another perspective rear view of the hood or shell of the device configured for attachment to a loop end of a recovery winch rope or cable, according to an example embodiment;

FIG. 15 is a drawing depicting a perspective rear view of the rope-configured cap or insert of the device configured for attachment to a loop end of a recovery winch rope or cable, according to an example embodiment;

FIG. 16 is a drawing depicting a side view of the rope-configured cap or insert of the device configured for attachment to a loop end of a recovery winch rope or cable, according to an example embodiment;

FIG. 17 is a drawing depicting a rear view of the rope-configured cap or insert of the device configured for attachment to a loop end of a recovery winch rope or cable, according to an example embodiment;

FIG. 18 is a drawing depicting another side view of the rope-configured cap or insert of the device configured for attachment to a loop end of a recovery winch rope or cable, according to an example embodiment;

FIG. 19 is a drawing depicting a top view of the rope-configured cap or insert of the device configured for attachment to a loop end of a recovery winch rope or cable, according to an example embodiment;

FIG. 20 is a drawing depicting a frontal view of the rope-configured cap or insert of the device configured for attachment to a loop end of a recovery winch rope or cable, according to an example embodiment;

FIG. 21 is a drawing depicting another perspective rear view of the rope-configured cap or insert of the device configured for attachment to a loop end of a recovery winch rope or cable, according to an example embodiment;

FIG. 22 is a drawing depicting a perspective frontal view of the rope-configured cap or insert of the device configured for attachment to a loop end of a recovery winch rope or cable, according to an example embodiment;

FIG. 23 is a drawing depicting a perspective rear view of the cable-configured cap or insert of the device configured for attachment to a loop end of a recovery winch rope or cable, according to an example embodiment;

FIG. 24 is a drawing depicting a side view of the cable-configured cap or insert of the device configured for attachment to a loop end of a recovery winch rope or cable, according to an example embodiment;

FIG. 25 is a drawing depicting a rear view of the cable-configured cap or insert of the device configured for attachment to a loop end of a recovery winch rope or cable, according to an example embodiment;

FIG. 26 is a drawing depicting another side view of the cable-configured cap or insert of the device configured for attachment to a loop end of a recovery winch rope or cable, according to an example embodiment;

FIG. 27 is a drawing depicting a top view of the cable-configured cap or insert of the device configured for attachment to a loop end of a recovery winch rope or cable, according to an example embodiment;

FIG. 28 is a drawing depicting a frontal view of the cable-configured cap or insert of the device configured for attachment to a loop end of a recovery winch rope or cable, according to an example embodiment;

FIG. 29 is a drawing depicting another perspective rear view of the cable-configured cap or insert of the device configured for attachment to a loop end of a recovery winch rope or cable, according to an example embodiment;

FIG. 30 is a drawing depicting a perspective frontal view of the cable-configured cap or insert of the device configured for attachment to a loop end of a recovery winch rope or cable, according to an example embodiment.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed subject matter improves over the prior art by providing a simple, cost-effective and efficient apparatus configured for attachment to a loop end of a recovery winch rope or cable. The claimed device is not installed on the load path of the winching system, and therefore the capabilities of the system are not limited by introducing an additional failure point. By not being installed along installed along the load path between the stationary object and the rope or cable, the claimed device cannot compromise the integrity of the load path in the event that a manufacturing or material defect occurs. Also, since the claimed device is not loaded, no damage can occur from load use and fatigue wear. Further, the cost of manufacturing the claimed device can be inexpensive and time efficient, since there are no load-bearing parts, and the materials used need not be certified and monitored.

Additionally, the claimed device may extend the useful life of the shackle and rope interface by eliminating asymmetrical loading of the shackle. Further, the claimed device may prevent damage and degradation of interfacing parts by dampening movement and vibration typically transferred from the shackle. Similarly, the claimed device may improve safety conditions in the event of a load failure due to the material used having energy absorbing characteristics. Finally, the claimed device may allow for an interchangeable insert to be used to retain the damper in the event that a shackle is not used, and parts can be replaced or upgraded to intelligent winching accessories.

There are also cosmetic considerations to the claimed device. When the rope or cable is pulled in or wound up, and the claimed device contacts the fairleads, the claimed device cannot scuff or scratch the fairlead, causing unsightly blemishes. Since the claimed device is composed or rubber, even heavy or rough off-road activity which causes significant vibrations, cannot cause the claimed device to cause damage to the fairlead. By the same token, the claimed device itself cannot become scuffed or scratched because it is composed of rubber.

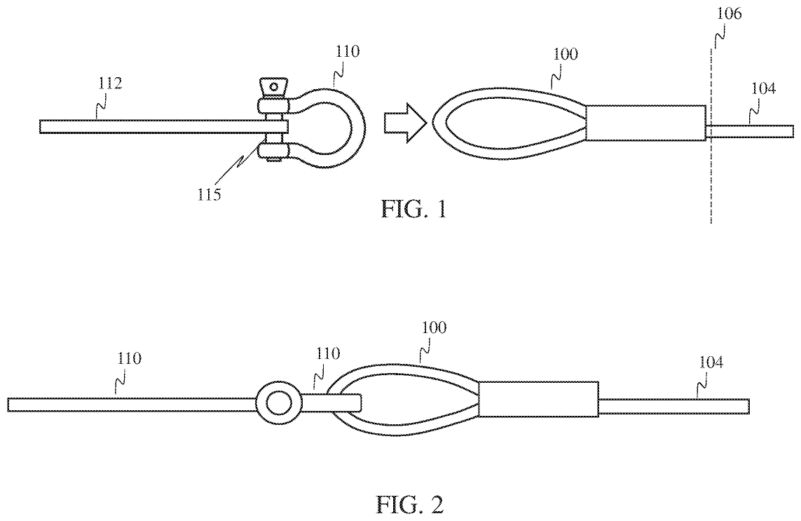

FIG. 1 is a drawing depicting a prior art loop end 100 of a recovery winch rope or cable 104 and a rope 112 attached to a D-ring 110. Conventionally, a recovery winch includes rope or cable 104 that is wrapped around a spool, wherein the rope or cable 104 terminates in a loop end 100. When the recovery winch is used to effectuate a recovery of the off-road vehicle, a rope or cable 112 is attached to a stationary object, such as a tree, and the recovery winch rope or cable 104 is let out or wound out. Then, the D-ring 110 is attached to the loop end 110 by removing the shackle pin 115, threading the D-ring 110 through the opening in the loop end 100, and re-inserting the shackle pin 115 into the D-ring, as shown in FIG. 2. Subsequently, the recovery winch is turned on, which winds up the rope or cable 104 and pulls the off-road vehicle, thereby recovering the off-road vehicle from the obstacle.

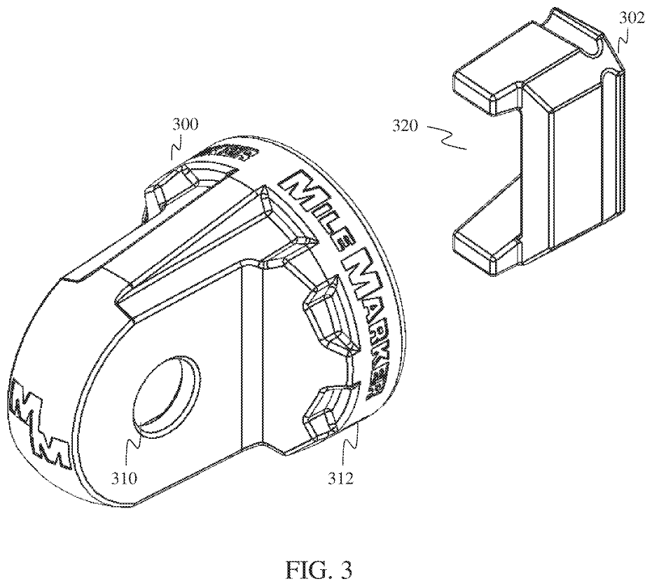

FIG. 3 is a drawing depicting a front perspective view of the device configured for attachment to a loop end of a recovery winch rope or cable, according to an example embodiment. FIG. 3 shows that the device is disassembled and comprises to main pieces: a hood element 300 (also referred to as a cover or a shell) and a removable cap 302 (also referred to as an insert) configured for insertion into the hood element. FIG. 3 shows that the device includes a hood element 300 configured to fit over and around the loop end of the recovery winch rope or cable, wherein the hood element 300 covers the loop end. FIG. 3 also shows that the device includes orifices 310 located on either side of the hood element 300 and aligned with an opening in the loop end, such that a continuous open space extends through the opening of the loop end. FIG. 3 also shows that the device includes a base 312 coupled to the hood element 300, the base 312 being sized to prevent passage through a fairlead of the recovery winch. FIG. 3 also shows that the device includes a removable cap 302 (also referred to as an insert) configured for insertion into the base 312, wherein the cap 302 includes a space 320 that allows the rope or cable to extend therethrough, and, wherein the hood element 300, the base 312 and the cap 302 are composed of an elastomeric polymer, such as rubber.

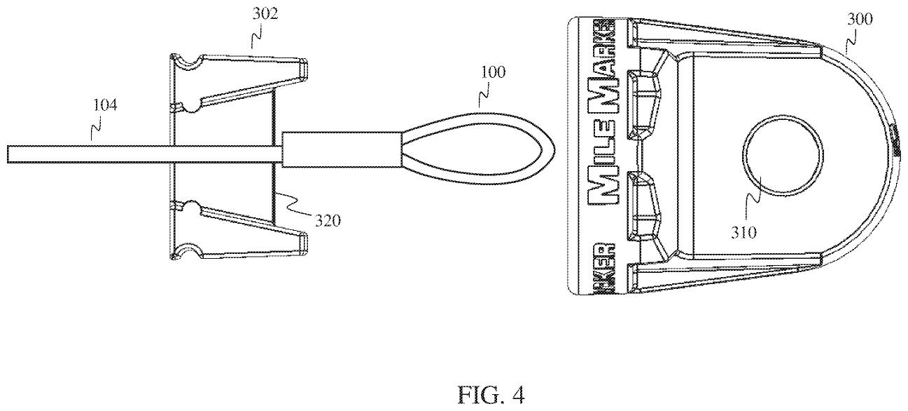

FIG. 4 is a drawing depicting a side view of the device configured for attachment to the loop end 100 of a recovery winch rope or cable 104, according to an example embodiment. FIG. 3 shows that the device is disassembled, and the loop end 100 is shown. FIG. 4 shows that the device includes orifices 310 located on either side of the hood element 300, configured to be aligned with the opening in the loop end, such that a continuous open space extends through the opening of the loop end. FIG. 4 also shows that the device includes a removable cap 302 configured for insertion into the base 312, wherein the cap 302 includes a space 320 that allows the rope or cable to extend therethrough.

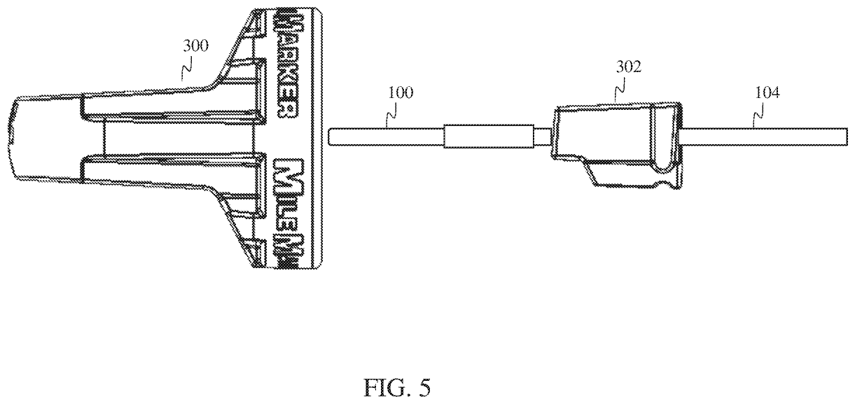

FIG. 5 is a drawing depicting a top view of the device configured for attachment to the loop end 100 of the recovery winch rope or cable 104, according to an example embodiment. FIG. 5 shows the hood element 300 and a removable cap 302, through which the rope or cable 104 extends, and wherein the hood element 300 includes a void configured to fit over and around the loop end 100, wherein the hood element 300 covers the loop end. In FIG. 5, the loop end has not been inserted into the void of the hood element yet.

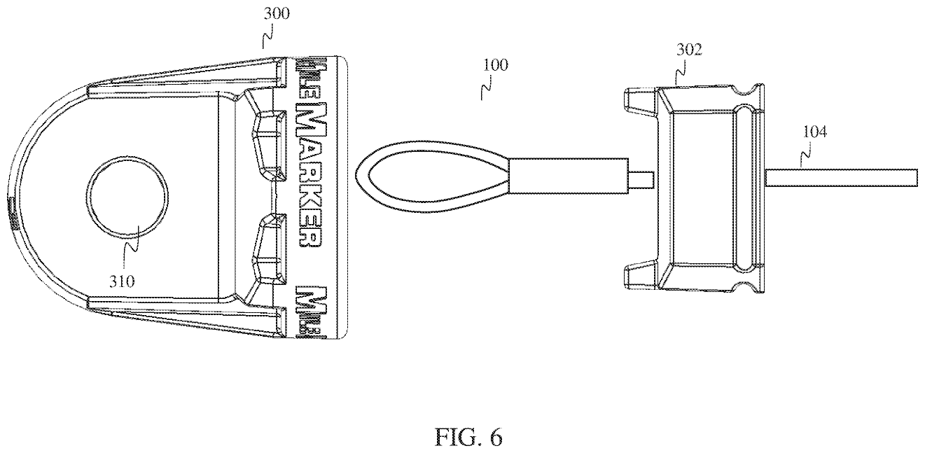

FIG. 6 is a drawing depicting another side view of the device configured for attachment to a loop end 100 of the recovery winch rope or cable 104, according to an example embodiment. In FIG. 6, the loop end 100 has not been inserted into the void of the hood element 300 yet. FIG. 6 shows that when the loop end 100 is inserted into the void of the hood element 300, the device includes orifices 310 located on either side of the hood element 300 and aligned with the opening in the loop end 100, such that a continuous open space extends through the opening of the loop end.

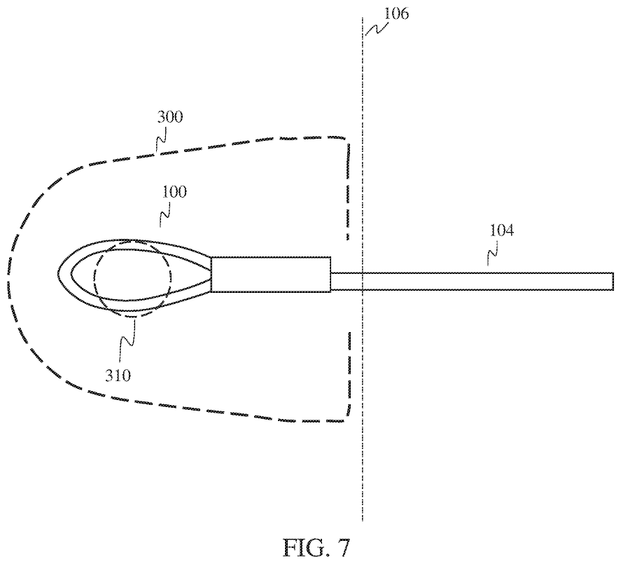

FIG. 7 is a drawing depicting an interior side view of the device configured for attachment to the loop end 100 of a recovery winch rope or cable 104, with the loop end 100 inserted into the device, according to an example embodiment. FIG. 7 shows a dotted outline of the hood element 300 so as to show the loop end 100 within the hood element. FIG. 7 shows that the loop end 100 has been inserted into the void of the hood element 300, and the orifices 310 located on either side of the hood element 300 are aligned with the opening in the loop end 100, such that a continuous open space extends through the opening of the loop end. FIG. 7 shows that the hood element 300 covers or surrounds the outward facing surfaces of the loop end 100.

The inward facing surfaces of the loop end 100, such as the portions of the surface of the rope or cable within the opening of the loop end that face toward the midpoint of the loop end are not covered. This arrangement allows for a D-ring (such as shown in FIG. 1), to be attached to the loop end 100 by removing the shackle pin 115, threading the D-ring 110 through the opening in the loop end 100, and re-inserting the shackle pin 115 into the D-ring, as shown in FIG. 2. Therefore, in this arrangement the claimed device is not installed along the load path between the D-ring and the rope or cable 104 and cannot compromise the integrity of the load path. The claimed device is not loaded, meaning there cannot be damage from load use and fatigue wear. Further, the cost of manufacturing the claimed device can be inexpensive and time efficient, since there are no load-bearing parts, and the materials used need not be certified and monitored.

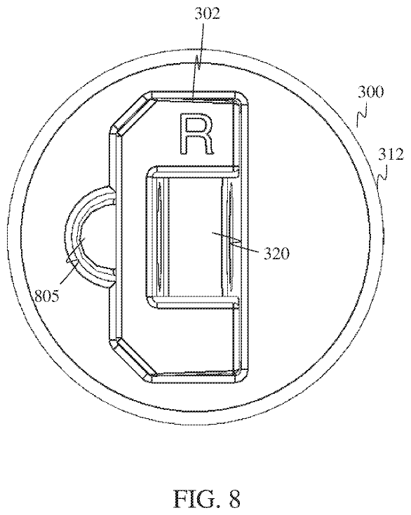

FIG. 8 is a drawing depicting a rear view of the device configured for attachment to the loop end 100 of a recovery winch rope or cable, according to an example embodiment. FIG. 8 also shows that the device includes a removable cap 302 (also referred to as an insert) configured for insertion into the base 312, wherein the cap 302 includes a space 320 that allows the rope or cable to extend therethrough. FIG. 8 also shows that the base 312 includes a U-shaped cutout 805, which provides a space for a user to insert a finger or a tool to remove the cap 302 when it is inserted into the base. When the cap 302 is inserted into the base 312, the cutout 805 remains an empty volume.

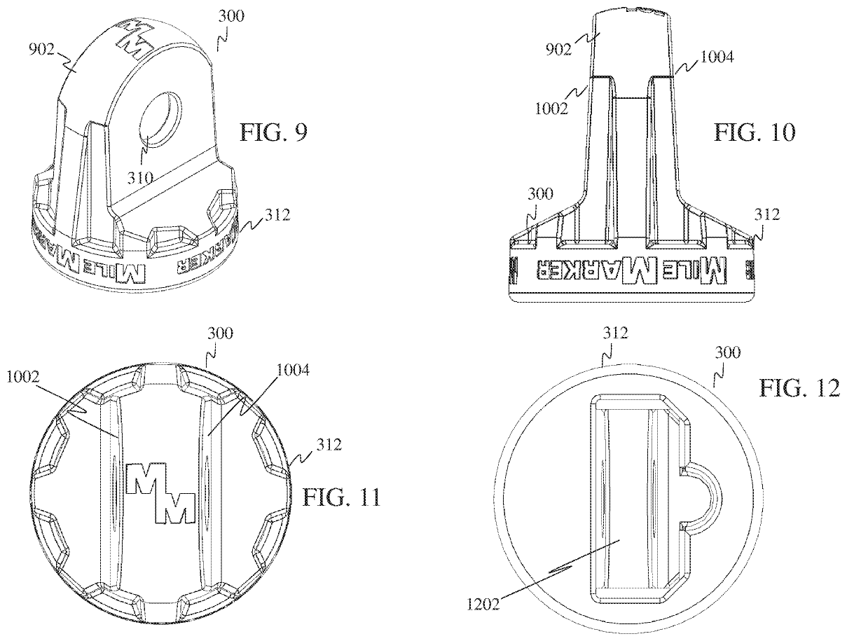

FIG. 9 is a drawing depicting a perspective frontal view of the hood or shell 300 of the device, while FIG. 10 is a drawing depicting a bottom view of the hood or shell 300 of the device, FIG. 11 is a drawing depicting a frontal view of the hood or shell of the device, and FIG. 12 is a drawing depicting a rear view of the hood or shell of the device. FIGS. 9-12 show that the hood element 300 includes a base 312 coupled to the hood element, the base 312 being sized to prevent passage through a fairlead of the recovery winch. FIGS. 9-12 also show that the hood element 300 also comprises two parallel planar elements 1002, 1004 joined by a curved element 902, which comprise a hood shape. The base 312 may comprise a ring-shape or disc-shape having a cavity 1202 configured to accept a distal end of the removable cap 302. Further, the orifices 310 are sized to accept a shackle pin, such as the shackle pin 115 for the D-ring 110.

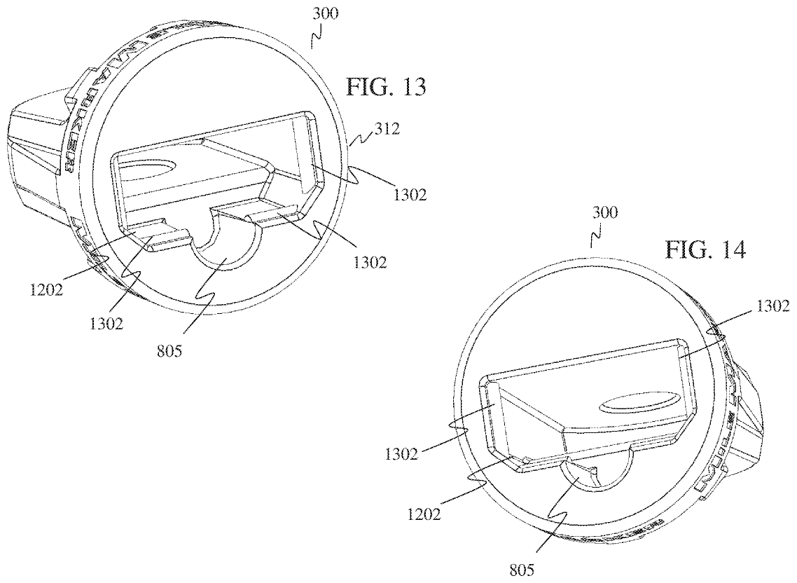

FIGS. 13 and 14 are drawings depicting two perspective rear views of the hood or shell 300 of the device configured for attachment to the loop end 100, according to an example embodiment. FIGS. 13 and 14 show that the base 312 comprises a ring-shape or disc-shape having a cavity 1202 configured to accept a distal end of the removable cap 302. The cavity 1202 shows the hollow nature of the hood or shell 300 and the interior view of the orifices 310 are also shown in FIGS. 13 and 14. The figures also show that the interior surface of the hood element 300 includes multiple protrusions 1302 for creating a friction fit with the removable cap 302 when the removable cap is inserted into the cavity 1202. The protrusions 1302 are shown as extended or elongated bumps or rounded bumpers that extend upwards from a flat surface. Consequently, the exterior surface of the removable cap 302 includes at least one détente (shown below) configured to mate with the protrusions to create a friction fit when the removable cap 302 is inserted into the cavity 1202. FIGS. 13 and 14 also show that the base 312 includes a U-shaped cutout 805, which provides a space for a user to insert a finger or a tool to remove the cap 302 when it is inserted into the cavity 1202.

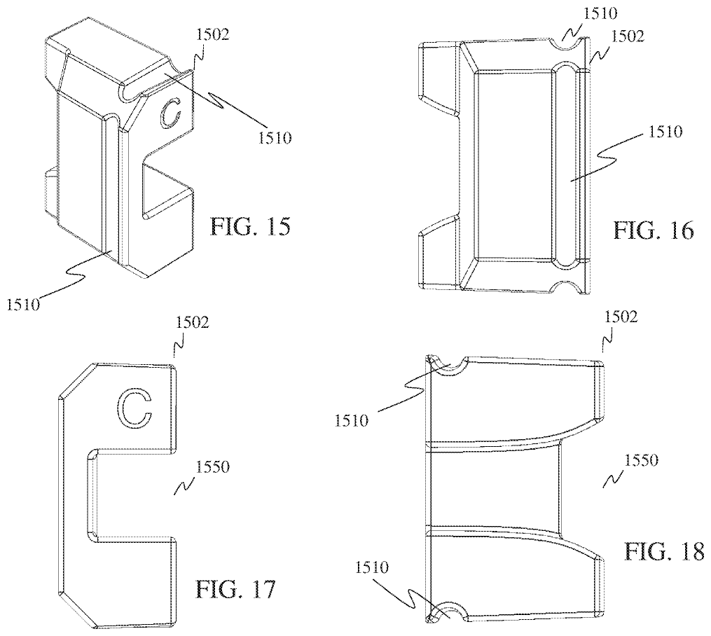

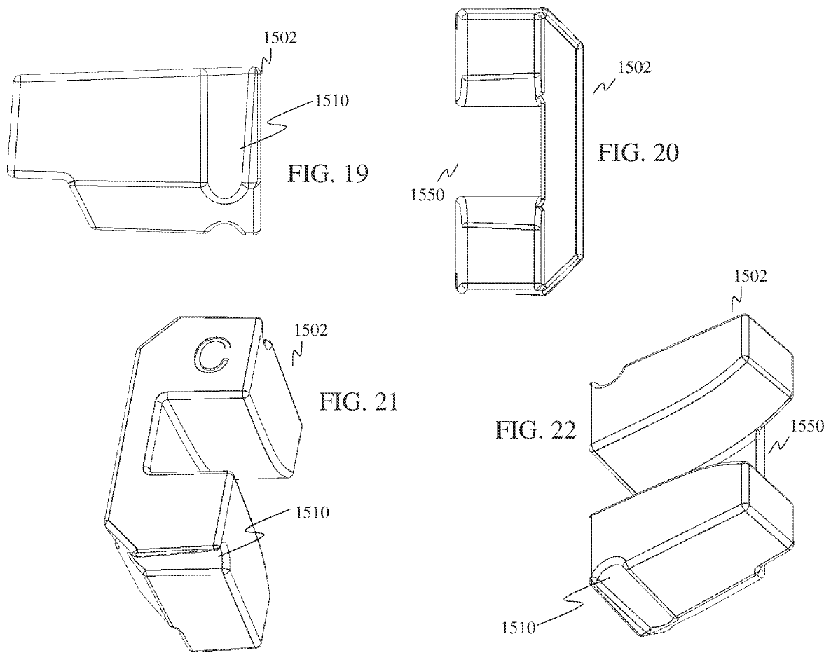

FIG. 15 is a drawing depicting a perspective rear view of the rope-configured cap or insert 1502 of the device, while FIG. 16 depicts a side view of the rope-configured cap or insert 1502, FIG. 17 depicts a rear view of the rope-configured cap or insert 1502, FIG. 18 depicts another side view of the rope-configured cap or insert 1502, FIG. 19 depicts a top view of the rope-configured cap or insert 1502, FIG. 20 depicts a frontal view of the rope-configured cap or insert 1502, FIG. 21 depicts another perspective rear view of the rope-configured cap or insert 1502, and FIG. 22 depicts a perspective frontal view of the rope-configured cap or insert 1502. The rope-configured cap or insert 1502 is configured to accept a rope, as opposed to a cable.

FIGS. 15-22 show that the rope-configured cap or insert 1502 includes multiple détentes or gutters 1510 that are sized and shaped (i.e., configured) to mate with the protrusions 1302 to create a friction fit when the removable cap 1502 is inserted into the cavity 1202. The détentes or gutters 1510 are shown as extended or elongated channels or rounded depressions that extend into a flat surface. FIGS. 15-22 also show a channel or space 1550 that allows the rope or cable 104 to extend therethrough when the cap or insert 1502 is inserted into the hood element 300. FIG. 18 shows that the sides of the channel or space 1550 are curved such that the channel narrows in the distal direction and widens in the proximal direction.

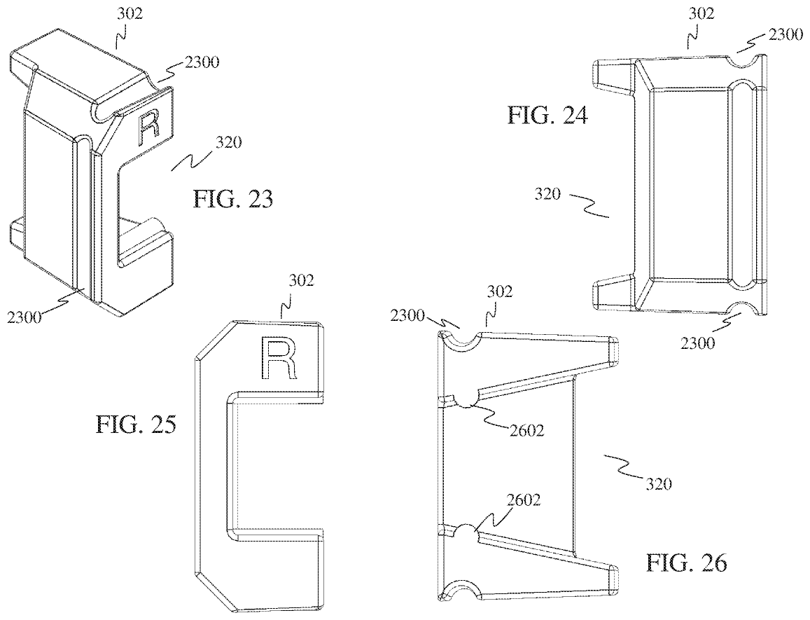

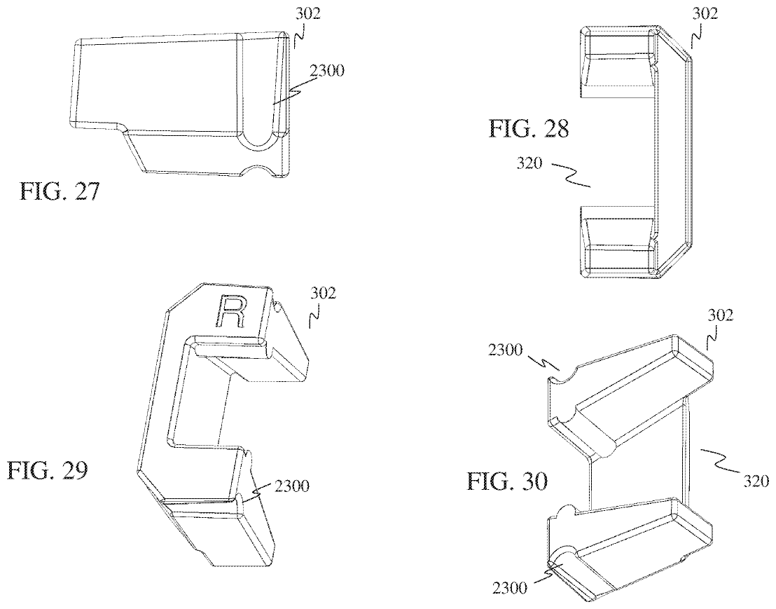

FIG. 23 is a drawing depicting a perspective rear view of the cable-configured cap or insert 302 of the device, while FIG. 24 depicts a side view of the cable-configured cap or insert 302, FIG. 25 depicts a rear view of the cable-configured cap or insert 302, FIG. 26 depicts another side view of the cable-configured cap or insert 302, FIG. 27 depicts a top view of the cable-configured cap or insert 302, FIG. 28 depicts a frontal view of the cable-configured cap or insert 302, FIG. 29 depicts another perspective rear view of the cable-configured cap or insert 302, and FIG. 30 depicts a perspective frontal view of the cable-configured cap or insert 302. The cable-configured cap or insert 302 is configured to accept a cable, as opposed to a rope.

FIGS. 23-30 show that the cable-configured cap or insert 302 includes multiple détentes or gutters 2300 that are sized and shaped (i.e., configured) to mate with the protrusions 1302 to create a friction fit when the removable cap 302 is inserted into the cavity 1202. The détentes or gutters 2300 are shown as extended or elongated channels or rounded depressions that extend into a flat surface. FIGS. 23-30 also show a channel or space 320 that allows the rope or cable 104 to extend therethrough when the cap or insert 302 is inserted into the hood element 300. FIG. 26 shows that the sides of the channel or space 320 are straight and that the channel narrows in the distal direction and widens in the proximal direction. FIG. 26 also shows that the sides of the channel or space 320 include protrusions 2602 that are configured to contact the cable when the loop end is inserted into the hood element. The purpose of the protrusions 3602 is to provide a surface on which the cable may rest or push against, so as to effectuate wear and tear on the protrusions, as opposed to the remainder of the claimed device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A device configured for attachment to a loop end of a recovery winch rope or cable, the device comprising:
a) a hood element configured to fit over and around a loop end of the recovery winch rope or cable, wherein the hood element covers outward facing surfaces of the loop end;
b) orifices located on either side of the hood element and aligned with an opening in the loop end, such that a continuous open space extends through the opening of the loop end;
c) a base coupled to the hood element, the base being sized to prevent passage through a fairlead of the recovery winch;
d) a removable cap located in the base, wherein the cap includes a space that allows the rope or cable to extend therethrough; and
e) wherein the hood element, the base and the cap are composed of an elastomeric polymer.

2. The device of claim 1, wherein the hood element comprises two parallel planar elements joined by a curved element.

3. The device of claim 2, wherein the orifices are sized to accept a shackle pin.

4. The device of claim 3, wherein the base comprises a circular ring having a cavity configured to accept a distal end of the removable cap.

5. The device of claim 4, wherein an interior surface of the hood element includes at least one protrusion for creating a friction fit with the removable cap when the removable cap is inserted into the cavity.

6. The device of claim 5, wherein an exterior surface of the removable cap includes at least one détente configured to mate with the at least one protrusion to create a friction fit when the removable cap is inserted into the cavity.

7. The device of claim 6, wherein the elastomeric polymer is rubber.

8. A device configured for attachment to a loop end of a recovery winch rope or cable, the device comprising:
a) a shell including a void configured to accept the loop end of the recovery winch rope or cable;
b) orifices located on either side of the shell and aligned with an opening in the loop end, such that a continuous open space extends through the opening of the loop end;
c) a base coupled to the hood element, the base being sized to prevent passage through a fairlead of the recovery winch;
d) a removable insert located in the base and at least partially filling the void of the shell, the insert configured to retain the loop end in the void, wherein the insert includes a space that allows the rope or cable to extend therethrough; and
e) wherein the shell, the base and insert are composed of an elastomeric polymer.

9. The device of claim 8, wherein the shell comprises two parallel planar elements joined by a curved element.

10. The device of claim 9, wherein the orifices are sized to accept a shackle pin.

11. The device of claim 10, wherein the base comprises a circular ring having a cavity configured to accept a distal end of the removable insert.

12. The device of claim 11, wherein an interior surface of the shell includes at least one protrusion for creating a friction fit with the removable insert when the removable insert is inserted into the cavity.

13. The device of claim 12, wherein an exterior surface of the removable insert includes at least one détente configured to mate with the at least one protrusion to create a friction fit when the removable insert is inserted into the cavity.

14. The device of claim 13, wherein the elastomeric polymer is rubber.

15. The device of claim 8, further comprising one or more sensors located in the shell and configured for collecting sensor data.

16. A device configured for attachment to a loop end of a recovery winch rope or cable, the device comprising:
a) a hollow cover including a void configured to accept the loop end of the recovery winch rope or cable;
b) orifices located on opposing sides of the cover and aligned with an opening in the loop end, such that a continuous open space extends through the opening of the loop end;
c) a ring-shaped base coupled to the proximal end of the cover;
d) a removable insert located in the base and at least partially filling the void of the cover, the insert configured to retain the loop end in the void, wherein the insert includes a cutout that allows the rope or cable to extend therethrough; and
e) wherein the cover, the base and the insert are composed of an elastomeric polymer.

9. (canceled)

17. The device of claim 16, wherein the orifices are sized to accept a shackle pin.

18. The device of claim 17, wherein the base comprises a cavity configured to accept a distal end of the removable insert.

19. The device of claim 18, wherein an interior surface of the cover includes at least one protrusion for creating a friction fit with the removable insert when the removable insert is inserted into the cavity.

20. The device of claim 19, wherein an exterior surface of the removable insert includes at least one détente configured to mate with the at least one protrusion to create a friction fit when the removable insert is inserted into the cavity.
